(19) United States
(12) Patent Application Publication
(10) Pub. No.: US 2014/0166772 A1
(43) Pub. Date: Jun. 19, 2014

(54) MECHANICAL APPLICATOR FOR HIGH VISCOUS MATERIALS

(71) Applicant: DOW AGROSCIENCES LLC, Indianapolis, IN (US)

(72) Inventors: Luis Enrique Gomez, Carmel, IN (US); Boris Antonio Castro, Clovis, CA (US); Garrick W. Stuhr, Mendota, CA (US); Agenor Mafra-Neto, Riverside, CA (US); Brett Roble, Riverside, CA (US)

(73) Assignee: DOW AGROSCIENCES LLC, Indianapolis, IN (US)

(21) Appl. No.: 13/803,781

(22) Filed: Mar. 14, 2013

Related U.S. Application Data
(60) Provisional application No. 61/739,581, filed on Dec. 19, 2012.

(51) Int. Cl. A01M 7/00

(52) U.S. Cl. CPC A01M 7/0042
USPC 239/8; 239/373; 239/172

(57) ABSTRACT

An apparatus and method for applying an agricultural management material to targeted area. Exemplary agricultural management materials include viscous materials.

### RELATED APPLICATIONS

This application claims the benefit of U.S. Provisional Patent Application Ser. No. 61/739,581, filed Dec. 19, 2012, titled MECHANICAL APPLICATOR FOR AGRICULTURAL MANAGEMENT MATERIALS, docket DAS-0290-01-US-E, the disclosure of which is expressly incorporated by reference herein.

This application relates to U.S. Provisional Patent Application Ser. No. 61/739,589, filed Dec. 19, 2012, titled AUTOMATED DEVICE FOR THE APPLICATION OF AGRICULTURAL MANAGEMENT MATERIALS, docket DAS-0284-01-US-E; U.S. Provisional Patent Application Ser. No. 61/739,605, filed Dec. 19, 2012, titled APPLICATION DEVICE DESIGNS FOR APPLYING AGRICULTURAL MANAGEMENT MATERIALS TO TARGETED SUBSTRATES, docket DAS-0285-01-US-E; and U.S. Provisional Patent Application Ser. No. 61/739,599, filed Dec. 19, 2012, titled EQUIPMENT DESIGNS FOR APPLYING AGRICULTURAL MANAGEMENT MATERIALS, docket DAS-0289-01-US-E, the disclosures of which are expressly incorporated by reference herein.

### FIELD

The present invention relates to methods and apparatus for delivering an agricultural management material and in particular to methods and apparatus for delivering a viscous pest control material to targeted substrates including one or more of agricultural crops, plants, structures, and substrates in the proximity thereof

### BACKGROUND

Viscous materials are used as specialized substrates for delivering pheromones and insecticides into agricultural settings such as orchards, plantations, groves, vineyards, or onto surrounding areas with the purpose of effecting pest control or management in the agricultural area. Existing application devices are unable to deliver highly viscous materials in a reliable time efficient and feasible manner. In addition, these typical devices are not suitable for large scale applications. Methods and apparatus for applying highly viscous materials, such as for pest control and pest management, that results in high levels of product deposition, controlled deposition of discrete or localized material, or both, on the target plant are desired.

### SUMMARY

In an exemplary embodiment of the present disclosure, an applicator system for applying a material to a targeted area is provided. The applicator system may apply a viscous material to the targeted area.

In one exemplary embodiment, an applicator system for applying an agricultural management material to a targeted area through the air is provided. The applicator system comprises a reservoir storing the agricultural management material; a pump which is in fluid communication with the reservoir and pressurizes a first portion of the agricultural management material; a material conduit in fluid communication with the pump to receive the first portion of the agricultural management material, the material conduit including a material outlet from which the first portion of the agricultural management material is emitted; a fluid source supplying a stream of fluid; and a fluid conduit in fluid communication with the fluid source to receive the stream of fluid, the stream of fluid flows through an interior of the fluid conduit to a fluid outlet, the fluid exiting the fluid conduit establishing a fluid flowpath external to the fluid conduit, wherein the agricultural management material exiting the material outlet of the material conduit contacts the fluid of the fluid flowpath and is propelled towards the targeted area.

In another exemplary embodiment, a method for applying an agricultural management material to a targeted area is provided. The method comprises passing a fluid through a fluid conduit and out of a fluid outlet of the fluid conduit to establish a fluid flowpath external to the fluid conduit; passing a first portion of the agricultural management material through a material conduit; pushing the first portion of the agricultural management material out of a material outlet of the material conduit so that the first portion contacts the fluid flowpath; and separating the first portion of the agricultural management material into a plurality of spaced apart dollops that are propelled towards the targeted area.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 is an exemplary material applicator system according to the present disclosure;

FIG. 2 illustrate an enlarged view of the material dispensing end of the applicator of FIG. 1;

FIG. 3 is another exemplary material applicator system according to the present disclosure;

FIG. 4 is the exemplary applicator of FIG. 2 mounted on a utility vehicle;

FIG. 4A is a representative view of the utility vehicle of FIG. 4; and

FIGS. 5A-5C show exemplary quantities of material applied by the exemplary embodiment of FIG. 4.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to the application of viscous materials onto agricultural or other plant substrates, it should be understood that the features disclosed herein may also have application to the application and delivery of other materials to other targets and for purposes other than delivering insecticides, attractants, or mixes thereof.

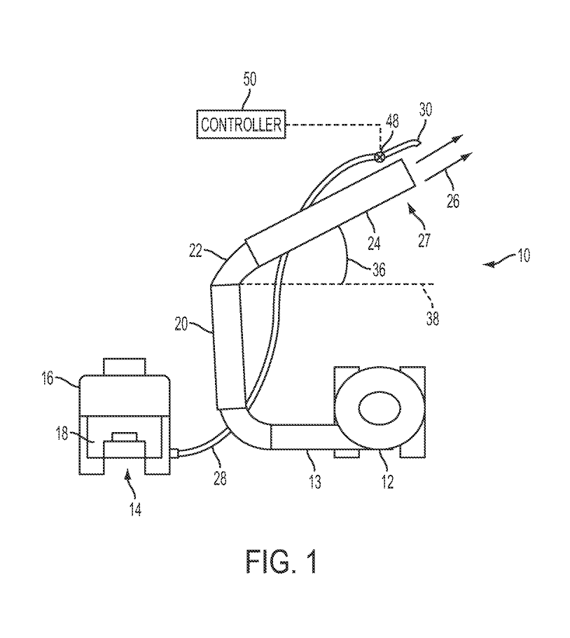

Referring first to FIG. 1, an exemplary material applicator system 10 is illustrated. Applicator system 10 applies an agricultural management material, such as a viscous material onto a targeted substrate. Exemplary agricultural management materials include pesticides, insecticides, pheromones, or other suitable viscous materials, onto a target. Suitable target substrates include trees, leaves, vines, stalks, and other suitable vegetation and plant substrates. Additional suitable target substrates include non-plant material in the area near the plant or crop, such as fence posts or other structures surrounding a field, orchard, plantation, or grove. Although the illustrated material is a viscous pest control material, other suitable agricultural management materials to be applied directly to or in the proximity of plants and plant substrates may also be used, including insecticide, pheromones lure or feeding attractant baiting technologies, sexual confusion technologies, attract and kill technologies, compounds affecting plant flowering or maturity, or other suitable materials. Suitable targets include trees, vines, stalks, and other suitable vegetation and plant substrates. In some embodiments, the applicator system reduces the amount of viscous material ending up in off-target locations like the ground, making a more efficient use of the viscous material.

In one embodiment, the present disclosure is directed to applying viscous agricultural management materials. Viscosity is a measure of the resistance of a fluid being deformed by either shear or tensile stress. Fluids with higher viscosity are observed as having a greater “thickness” or “internal friction,” while fluids with lower viscosity are observed as having a greater ease of movement or fluidity. In one embodiment, viscous materials include materials having a viscosity as low as about 1,000 cP, 2,000 cP, or 2,200 cP or as high as about 63,000 cP, 65,000, or 75,000 cP, or within any range defined by between any pair of the foregoing values. Exemplary methods of measuring viscosity include using a Brookfield DVI viscometer, available from Brookfield Engineering Laboratories, Inc., Middleboro, Mass. Exemplary test conditions include measuring the viscosity at 21° C. using a Brookfield DVI viscometer with a #6 or #7 spindle and a spindle speed of 100 rpm.

In the exemplary embodiment illustrated in FIG. 1, applicator system 10 includes a fluid source, illustratively a wind source 12, and a material source 14. Wind source 12 provides a source for a fluid stream to carry quantities of the material to be applied. Exemplary fluids include air, compressed gasses, and other suitable gasses, liquids, and vapors. Exemplary wind sources include blowers, such as backpack blowers, leaf blowers, compressed air tanks, air compressors, and other suitable wind sources. Exemplary materials include pest control materials. Exemplary pest control materials include viscous pest control materials.

In the illustrated embodiment, the outlet 13 of wind source 12 is coupled to a wind tubing 20 directing the outflow of air. Exemplary wind tubings 20 include pipes, tubes, and conduits formed from polyvinyl-chloride (PVC), polyethylene, or other suitable materials. Wind tubing 20 directs the outflow of blowing air from the wind source 12 to a delivery arm 24. Delivery arm 24 directs the blowing air leaving delivery arm 24 in the direction of arrows 26 towards the targeted tree or other plant.

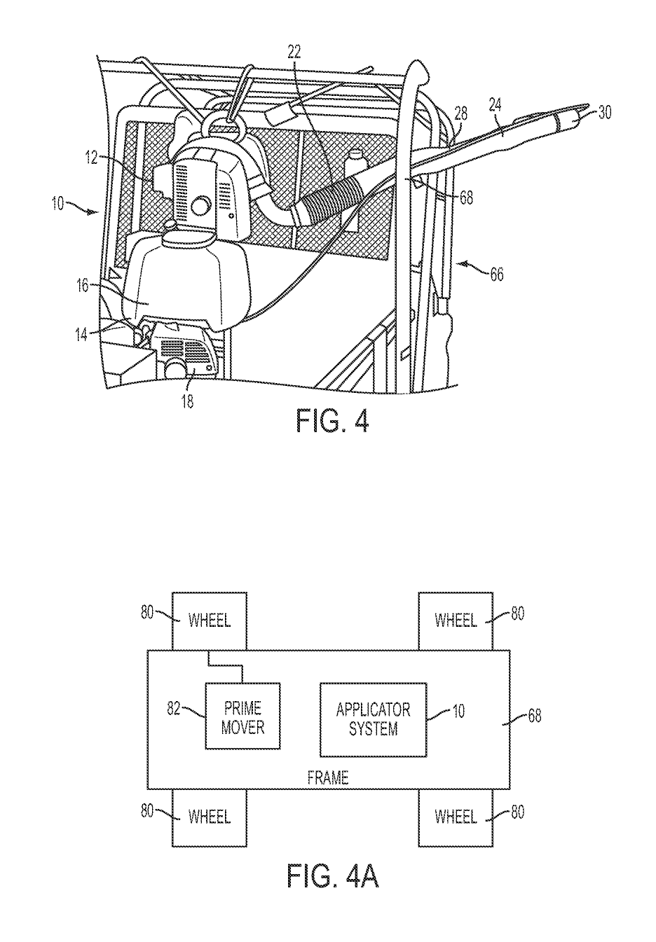

Wind tubing 20 illustratively includes one or more flexible sections 22. Flexible sections 22 allow delivery arm 24 to be adjusted. In one exemplary embodiment, flexible sections 22 allow for the angle 36 of the delivery arm 24 above a horizontal plane 38. Exemplary flexible sections 22 include flexible tubing, corrugated tubing, pivotable joints, and other sections allowing for orientation of delivery arm 24. In one exemplary embodiment, delivery arm 24 is coupled to a rigid frame to maintain the orientation 26 of the stream of air leaving the delivery arm (see FIG. 4). Referring to the exemplary embodiment illustrated in FIGS. 1 and 4, the orientation of the stream of air 26 leaving delivery arm 24 is adjusted by adjusting the angle 36 between delivery arm 24 and a horizontal plane 38 is adjusted by moving delivery arm 24 and adjusting flexible section 22. Increasing angle 36 results in a more vertical orientation of the stream of air 26 and a higher trajectory for material carried by the stream of air, while decreasing angle 36 results in a more horizontal orientation of the stream of air 26 and a lower trajectory for material carried by the stream of air.

Material source 14 provides a source of the material to the applicator system 10. In one exemplary embodiment, the material is a material having a viscosity as low as about 1,000 cP, 2,000 cP, or 2,200 cP or as high as about 63,000 cP, 65,000 cP, or 75,000 cP, or within any range defined by between any pair of the foregoing values.

In one exemplary embodiment, material source 14 includes a material reservoir 16 and a positive suction and displacement mechanism, such as a piston pump 18. Additional exemplary positive suction and displacement mechanisms include gas pumps, electric pumps, other suitable pumps, and other suitable devices or other suitable gas or electric pumps. Exemplary material sources 14 include motorized sprayers, such as gas-powered power sprayers available from Hudson a Power Sprayer available from H.D. Hudson Manufacturing Co., and other suitable pumps and reservoirs.

As illustrated in FIG. 1, piston pump 18 is coupled to material delivery tubing 28. Piston pump 18 pressurizes material from reservoir 16 and transports it through material delivery tubing 28 to wand 30. Wand 30 is positioned above an end 27 of delivery arm 24.

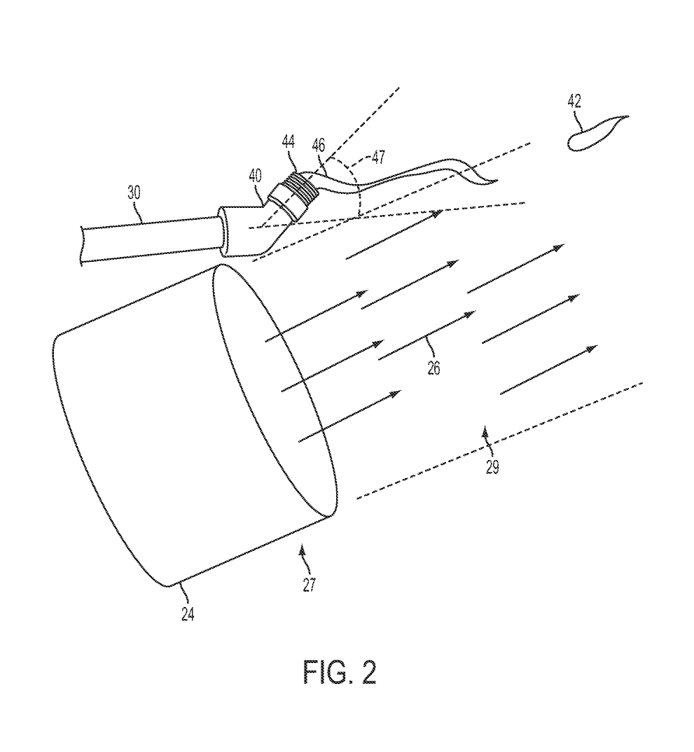

Referring to FIG. 2, material 46 exits wand 30 above the end 27 of delivery arm 24. A quantity of material, such as dollop 42, falls into the stream of air 26 leaving delivery arm 24. The stream of air 26 carries the dollop 42 away from applicator system 10 and towards the targeted area. As illustrated in FIG. 2, the stream of air external to the delivery arm 24 defines an air flowpath 29 that contacts material exiting the material outlet of the material conduit and propels the material towards the targeted area. Although air is shown in the illustrated embodiment as the fluid provided by delivery arm 24, other fluids may be used. In one embodiment, a liquid fluid is provided by delivery arm 24. In one embodiment, delivery arm 24 supports a nozzle which shapes the flowpath 29. In one exemplary embodiment, the outlet 44 of wand 30 includes a nozzle (not shown). Exemplary nozzles include nozzles to decrease the diameter of outlet 44, nozzles configured to reduce the size of the dollop 42, and nozzles configured to produce multiple dollops 42.

Referring to FIG. 2, in one exemplary embodiment the size and shape of the dollop 42 is controlled using the orientation of the outlet 44 of wand 30. As illustrated in FIG. 2, wand 30 includes elbow 40 positioned near the end of wand 30. In the illustrated embodiment, elbow 40 is formed from a 45° elbow and is rotatably connected to the remainder of wand 30. The size and shape of the dollops 42 is partially determined by the orientation of the elbow 40. As the orientation of rotatable elbow 40 is changed relative to wand 30, the shape and size of the dollops 42 or droplets changes. In a first orientation, as shown in FIG. 2, elbow 40 is oriented such that the outlet 44 of wand 30 is oriented up and away from the stream of air 26 from the end 27 of delivery arm 24 by an angle 47. In the illustrated embodiment, angle 47 has a value of about 45 degrees. In this orientation, a larger amount of material 44 collects on outlet 44 prior to falling as a mass into the stream of air 26, resulting in more discrete dollops 42 of material. In a second orientation (not shown), elbow 40 is oriented such that the outlet 44 of wand 30 is oriented down and towards the stream of air 26. In this orientation, material 44 falls directly from outlet 44 into the stream of air 26, resulting in longer and less round shapes. Elbow 40 is capable of being positioned in additional orientations in which the elbow 40 is oriented first up orientation and second down orientation to produce other shapes and sizes of dollops 42. In the illustrated embodiment, elbow 40 is manually moved between orientations. In one exemplary embodiment (not shown), the orientation of elbow 40 is controlled by controller 50.

Referring again to FIG. 1, in the illustrated embodiment, applicator system 10 further includes valve 48 and controller 50. In one embodiment, controller 50 controls valve 48 to regulate the size and frequency of dollops 42 emitted from the applicator system 10. Exemplary valves 48 include solenoid valves.

In one exemplary embodiment, controller 50 controls the size of dollops 42 emitted from applicator system 10. In this embodiment, the size of the dollops 42 is at least partially determined by the length of time valve 48 is opened. Controller 50 increases the size of the dollop 42 by opening valve 48 for a longer period of time. The longer period of time allows more material 44 to be emitted from outlet 44 of wand 30. Controller 50 decreases the size of the dollop 42 by opening valve 48 for a shorter period of time. The shorter period of time allows less material 46 to be emitted from outlet 44 of wand 30, and the smaller amount of material 44 falls into the stream of air 26 to be carried away as a dollop 42.

In one exemplary embodiment, controller 50 controls the frequency of dollops 42 emitted from the applicator system 10. Controller 50 increases the frequency of the dollops 42 emitted by reducing the time between subsequent opening of valve 48. Controller 50 decreases the frequency of the dollops 42 emitted by increasing the time between subsequent opening of valve 48.

In the illustrated embodiment, the stream of air 26 preserves the consistency of the dollop 42 that comes out of the wand 30. Various sizes and shapes of dollops 42 are produced by varying the orientation of elbow 40 and settings of controller 50. The illustrated embodiment provides an advantage over other applicators that have been found to break the dollop into smaller dollops or droplets or produce material having an elongated string-like consistency.

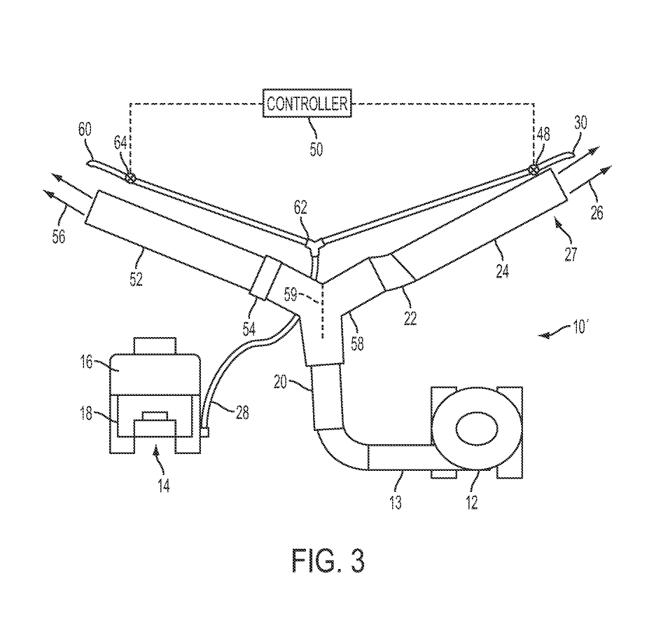

Referring next to FIG. 3, another exemplary material applicator system 10′ is illustrated. Applicator system 10′ is similar to applicator system 10. Applicator system 10′ is configured to dispense multiple dollops 42. Applicator system 10′ includes a second delivery arm 52 attached to wind tubing 20 and a second wand 60 attached to material tubing 28.

In the illustrated embodiment, delivery arm 24 and second delivery arm 52 are attached to wind source 12 through dividing tube 58. Dividing tube 58 divides the stream of air from wind source 12 between delivery arm 24 and second delivery arm 52. Second delivery arm 52 directs the stream of air leaving delivery arm 52 in the direction of arrows 56 towards the targeted tree or other plant.

Second delivery arm 52 is illustratively connected to dividing tube 58 through one or more flexible sections 54, similar to flexible sections 22. Flexible sections 54 allow second delivery arm 52 to be adjusted. In one exemplary embodiment, second delivery arm 54 is coupled to a rigid frame to maintain the orientation 56 of the stream of air leaving the delivery arm (see FIG. 4).

In one embodiment, at least one of wind tubing 20 and dividing tube 58 includes one or more baffles 59. In the illustrated embodiment, internal baffle 59 assists in splitting fluid flow evenly between first delivery arm 24 and second delivery arm 52. In one embodiment, baffle 59 is fixed in the interior of wind tubing 20. In another embodiment, baffle 59 is moveable to adjust the proportion of fluid flow between first delivery arm 24 and second delivery arm 52.

In one exemplary embodiment the end 27 of one or both of delivery arms 24, 52 includes a nozzle (not shown) to shape the flow of the stream of air 26 leaving the delivery arm 24, 52. Exemplary nozzles include nozzles configured to narrow the stream of air 26, nozzles configured to orient the stream of air 26, and nozzles configured to split the stream of air 26 into multiple streams.

As illustrated in FIG. 3, piston pump 18 provides pressurized material through material delivery tubing 28 to first wand 30 and second wand 60. Material divider 62 divides the material from material source 14 between first wand 30 and second wand 60. In one exemplary embodiment, second wand 60 includes a rotatable elbow 40, similar to elbow 40 of wand 30 to control the size and shape of dollops 42.

In the illustrated embodiment, applicator system 10′ further includes second valve 64 controlled by controller 50. Second valve 64 is similar to valve 48. In the illustrated embodiment, controller 50 controls valve 48 to regulate the size and frequency of dollops 42 applied by applicator system 10′ through first delivery arm 24 and controls valve 64 to regulate the size and frequency of dollops 42 applied by the applicator system 10′ through second delivery arm 52. The controller 50 may also control the positioning of the delivery arms 24, 52.

Referring next to FIG. 4, the exemplary viscous material applicator system 10 is illustrated attached to a vehicle 66. In the illustrated embodiment, vehicle 66 is a utility vehicle. Other suitable vehicles, including tractors, trucks, automobiles, and all-terrain vehicles, may also be used. As represented in FIG. 4A, vehicle 66 includes a plurality of ground engaging members, illustratively wheels 80, which support frame 68. Vehicle 66 further includes a prime mover 82 which is operatively coupled to at least one of the wheels 80 to propel the vehicle 66 relative to the ground. Exemplary prime movers include an electric motor, an internal combustion engine, and other devices.

As illustrated in FIG. 4, the angle 36 (see FIG. 1) of delivery arm 24 is set by coupling delivery arm 24 to a frame 68 of vehicle 66. In the illustrated embodiment, frame 68 is the frame of vehicle 66, but other suitable attachment locations may also be used. In another embodiment, applicator system 10 includes an applicator frame (not shown), and the angle 36 of delivery arm 24 is changed by removably coupling delivery arm 24 to different portions of the applicator frame.

Referring next to FIG. 1, a method of using an exemplary embodiment of an applicator system 10 according to the present disclosure is described. A material for application to the targeted area is provided in the material reservoir 16 of material source 14. Piston pump 18 pressurizes the material and provides it through material delivery tubing 28 to wand 30 for delivery to the targeted area.

Wind source 12 generates an air flow through wind tubing 20, exiting through a delivery arm 24 in the direction indicated by arrows 26. The angle 36 of the delivery arm 24 is adjusted to achieve a desired orientation for delivery arm 24.

Referring next to FIG. 2, valve 48, controlled by controller 50, dispenses a quantity of the material 46 through outlet 44. As material 46 is emitted through outlet 44, it falls into the path of the stream of air 26. A dollop 42 of material breaks off the material 46 being emitted from outlet 44 and is carried by the stream of air in the direction indicated by arrows 26 towards the targeted area. In one exemplary embodiment, dollops are delivered to a targeted area about 20 feet or more from the applicator system 10.

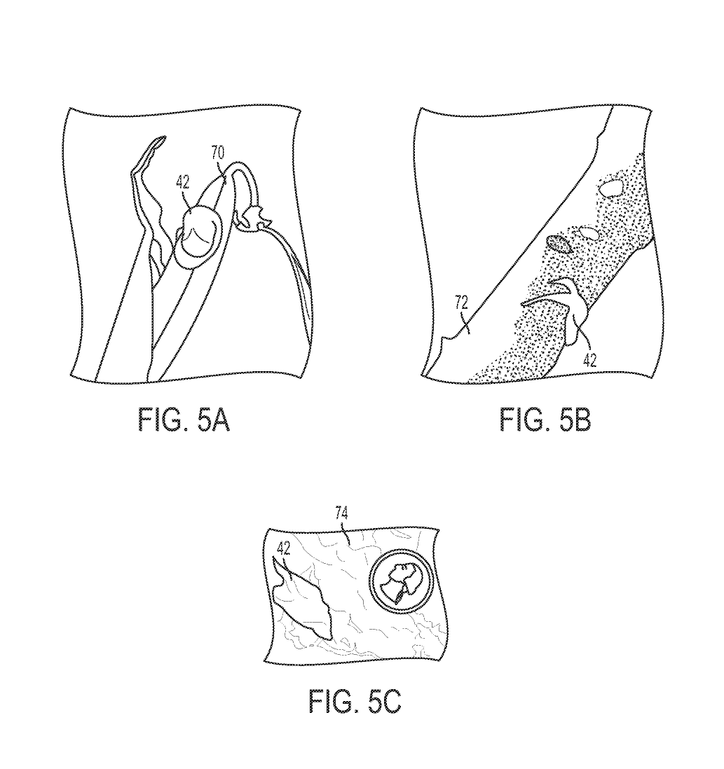

Referring to FIG. 4, in one embodiment applicator system 10 is attached to a vehicle 66. Vehicle 66 is driven along a row of targeted plants, such as trees in an orchard. As vehicle 66 passes the targeted plants, applicator system 10 dispenses dollops 42 of the material towards the targeted plants. FIGS. 5A-5C illustrate the dollops 42 of material upon contact with the targeted area. FIG. 5A illustrates a dollop 42 that has contacted and stuck to a leaf 70. FIG. 5B illustrates a dollop 42 that has contacted and stuck to a tree limb 72. FIG. 5C illustrates a dollop 42 that has contacted the ground 74.

As illustrated in FIG. 3, in another embodiment, applicator system 10′ includes two or more delivery arms 24, 52. In one exemplary embodiment (not shown), applicator system 10′ is attached to a vehicle 66. In this embodiment, delivery arm 24 delivers dollops 42 of material to a first row of targeted plants on a first side of vehicle 66 and delivery arm 52 delivers dollops 42 of material to a second row of targeted plants on a second side of vehicle 66. As illustrated in FIG. 3, the size and frequency of dollops 42 is controlled by controller 50 opening and closing valves 48, 64 on wands 30, 60.

While this invention has been described as relative to exemplary designs, the present invention may be further modified within the spirit and scope of this disclosure. Further, this application is intended to cover such departures from the present disclosure as come within known or customary practice in the art to which this invention pertains.

1. An applicator system for applying an agricultural management material to a targeted area through the air, comprising:
a reservoir storing the agricultural management material;
a pump which is in fluid communication with the reservoir and pressurizes a first portion of the agricultural management material;
a material conduit in fluid communication with the pump to receive the first portion of the agricultural management material, the material conduit including a material outlet from which the first portion of the agricultural management material is emitted;
a fluid source supplying a stream of fluid;
a fluid conduit in fluid communication with the fluid source to receive the stream of fluid, the stream of fluid flows through an interior of the fluid conduit to a fluid outlet, the fluid exiting the fluid conduit establishing a fluid flowpath external to the fluid conduit, wherein the agricultural management material exiting the material outlet of the material conduit contacts the fluid of the fluid flowpath and is propelled towards the targeted area.

2. The applicator system of claim 1, wherein the material outlet is positioned over the fluid flowpath such that when a quantity of the first portion of the agricultural management material is emitted from the material outlet, the quantity of the agricultural management material falls into the fluid flowpath.

3. The applicator system of claim 2, wherein the fluid of the fluid flowpath separates the quantity of the agricultural management material from a remainder of the agricultural management material.

4. The applicator system of claim 3, wherein the quantity of the agricultural management material is a dollop.

5. The applicator system of claim 1, wherein the fluid is air.

6. The applicator system of claim 5, wherein the agricultural management material is a viscous material.

7. The applicator system of claim 6, wherein the agricultural management material is a pest control material.

8. The applicator system of claim 6, wherein the agricultural management material has a viscosity from about 2,000 cP to about 63,000 cP.

9. The applicator system of claim 1, further comprising a valve which controls a flow of the agricultural management material from the reservoir to the material outlet of the material conduit.

10. The applicator system of claim 1 wherein the fluid conduit includes a first portion and a second portion, the second portion being moveable relative to the first portion to adjust a direction of the fluid flowpath.

11. The applicator system of claim 1, further comprising
a frame;
a plurality of ground engaging members, the frame being supported by the plurality of ground engaging members; and
a prime mover operatively coupled to at least one of the plurality of ground engaging members to propel the frame relative to a ground surface, wherein the agricultural management material reservoir, the pump, the material conduit, the fluid source, and the fluid conduit are supported by the plurality of ground engaging members.

12. A method for applying an agricultural management material to a targeted area, the method comprising the steps of:
passing a fluid through a fluid conduit and out of a fluid outlet of the fluid conduit to establish a fluid flowpath external to the fluid conduit;
passing a first portion of the agricultural management material through a material conduit;
pushing the first portion of the agricultural management material out of a material outlet of the material conduit so that the first portion contacts the fluid flowpath; and
separating the first portion of the agricultural management material into a plurality of spaced apart dollops that are propelled towards the targeted area.

13. The method of claim 12, wherein the agricultural management material is a viscous material.

14. The method of claim 13, wherein the agricultural management material has a viscosity from about 1,000 cP to about 75,000 cP.

15. The method of claim 13, wherein the agricultural management material has a viscosity from about 2,000 cP to about 63,000 cP.

16. The method of claim 12, wherein the agricultural management material is a pest control material.
